(19) United States
(12) Patent Application Publication
(10) Pub. No.: US 2009/0322262 A1
(43) Pub. Date: Dec. 31, 2009

(54) Controller For Permanent Magnet Synchronous Motor and Motor Control System

(75) Inventors: Kazuaki Tobari, Hitachiota (JP); Shigehisa Aoyagi, Hitachi (JP); Satoshi Sumita, Hitachi (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/490,850

(22) Filed: Jun. 24, 2009

(30) Foreign Application Priority Data
Jun. 25, 2008 (JP) 2008-165261

(51) Int. Cl. H02P 21/14

(52) U.S. Cl. 318/400.02

(57) ABSTRACT

A motor control system includes a power converter, a vector controller for controlling the power converter, an axial error estimating operation for estimating an axial error which is a deviation between the phase estimation value and phase value of the motor, and a rotational speed estimating computing unit 5 for performing control so as to equalize the estimation value to a command of the axial error, a motor constant identification computing unit. The motor constant identification computing unit identifies a motor constant with a q-axis voltage component and a rotational speed identified value or a rotational speed command to reflect the identified motor constant in the vector controller.

### CROSS REFERENCE TO RELATED APPLICATIONS

This application claims the foreign priority benefit under Title 35, United States Code, §119(a)-(d) of Japanese Patent Application No. 2008-165261, filed on Jun. 25, 2008 in the Japan Patent Office, the disclosure of which is herein incorporated by reference in its entirety.

### BACKGROUND OF THE INVENTION

1. Field of the Invention

The present invention relates to a controller with identifying a motor constant for a permanent magnet synchronous motor and a motor controlling system with identifying a motor constant.

2. Description of the Related Art

A technology of identifying a motor constant is known in a sensor-less vector control method of controlling a motor without a position sensor. JP 2004-7924A discloses a technology of performing an identifying operation of a counter voltage coefficient φ with a counter voltage coefficient identifier through an operation given in Eq. (1) using: a motor input voltage Vqₑₛₜ, coordinate-converted regarding a rotational axis of a motor obtained from an axial error obtained by a motor axial estimator for a motor and a rotational coordinate axis of an inverter; currents Idₑₛₜ and Iqₑₛₜ flowing in a motor; a rotational angular velocity ω1; a resistance component R of the motor windings; and a d-axis inductance component Ld.

$$φ = \frac{1}{{ω}_{1}} ( {Vq}_{est} - {ω}_{1} \cdot Ld \cdot {Id}_{est} - R \cdot {Iq}_{est} ) \qquad ( 1 )$$

### SUMMARY OF THE INVENTION

A first aspect of the present invention provides a controller for a permanent magnet synchronous motor, comprising: a current detector configured to detect a current flowing through the permanent magnet synchronous motor; a vector controller configured to, on the basis the detected current, generate a control signal for controlling a power converter to be connected to the permanent magnet synchronous motor; an axial error estimation computing unit configured to estimate an axial error information which is a difference between a phase estimation value obtained by integrating a rotational speed estimation value of the permanent magnet synchronous motor and a phase value of the permanent magnet synchronous motor and generate a q-axis voltage component value on the basis of voltage command signals and the detected current; a rotational speed estimation value computing unit configured to perform control so that the axial error information estimated by the axial error estimation computing unit is identical with an axial error information command; and a motor constant identification computing unit configured to identify a motor constant of the permanent magnet synchronous motor with the q-axis voltage component value and either of the rotational speed estimation value of the permanent magnet synchronous motor or a rotational speed command and reflect the identified motor constant in controlling the power converter by the vector controller.

A second aspect of the present invention provides the controller based on the first aspect, wherein the identified motor constant comprises an induced voltage coefficient of the permanent magnet synchronous motor and a setting error of a winding resistance of the permanent magnet synchronous motor, and the axial error estimation computing unit computes the q-axis voltage component value from a sum of a product of the setting error of the winding resistance and a detected q-axis current value and a product of the rotational speed estimation value and the induced voltage coefficient.

According to the second aspect, the motor constant can be identified with: the q-axis voltage component (X=(R−(R*+ΔR̂))·Iqc+ω1·Ke) computed from a sum of a product of the setting error in the winding resistance ΔR and the q-axis current Iqc detected and coordinate-converted and a product of the rotational speed estimation value ω1 and the induced voltage coefficient Ke*; and with the rotational speed estimation value ω1 or a rotational speed command. In the q-axis voltage component X, a term (R−(R*+ΔR̂))·Iqc of the winding resistance R is neglected at the high rotational range where the rotational speed estimation value ω1 is relatively large. On the other hand, at a low rotational speed range where the rotational speed estimation value ω1 is relatively small, the q-axis voltage component X depends on the term (R−(R*+ΔR̂))·Iqc.

In other words, (1) at the low rotational speed range, “a product of the rotational speed estimation value and the setting value of the induced voltage coefficient” is subtracted from the q-axis voltage components in the axial error estimation operation. On the basis of the subtraction value, the winding resistance value of the permanent magnet synchronous motor is identified. (2) At a high rotational speed range, the induced voltage coefficient can be identified on the basis of a ratio between a q-axis voltage component value obtained by an axial error estimation operation and a “product of the rotational speed estimation value and a setting value of the induced voltage coefficient”.

Preferably, the low rotational speed range is defined by that a product of a ratio between the setting value of the resistance and the induced voltage coefficient, multiplied by the q-axis current commend or the current detection value, is equal to or smaller than a first rotational speed setting level value which is arbitrary set and equal to or smaller than several percents of the rated rotational speed.

The high rotational speed range is defined by that the product of a ratio between the setting value of the resistance and the induced voltage coefficient, multiplied by the q-axis current commend or the current detection value, is equal to or greater than a second rotational speed setting level value which is arbitrary set and equal to or greater than tens percents of the rated rotational speed.

A third aspect of the present invention provides a system including a permanent magnet synchronous motor, a power converter connected to the permanent magnet synchronous motor, and the controller based on the first aspect.

### BRIEF DESCRIPTION OF THE DRAWINGS

The object and features of the present invention will become more readily apparent from the following detailed description taken in conjunction with the accompanying drawings in which:

FIG. 1 is a block diagram of a motor control system of a first embodiment according to the present invention;

FIGS. 2A and 2B show a control characteristic at a low rotational speed range when R=R* in a case simulated by the inventor where the motor constant identification is omitted in the motor control system according to the present invention;

FIGS. 3A and 3B show a control characteristic at the low rotational speed when R=1.2×R* in the case simulated by the inventor where the motor constant identification is omitted in the motor control system according to the present invention;

FIGS. 4A and 4B show a control characteristic at a high rotational speed when Ke=Ke* in the case simulated by the inventor where the motor constant identification is omitted in the motor control system according to the present invention;

FIGS. 5A and 5B show a control characteristic at the high rotational speed when Ke=0.8×Ke* in the case simulated by the inventor where the motor constant identification is omitted in the motor control system according to the present invention;

FIG. 6 is a partial block diagram of a signal generator for the low rotational speed range included in the motor constant identifying computing unit;

FIG. 7 is a partial block diagram of a part of the motor constant identifying computing unit operated at the low rotational speed range;

FIG. 8 is a partial block diagram of a signal generator for the high rotational speed range included in the motor constant identifying computing unit;

FIG. 9 is a partial block diagram of a part of the motor constant identifying computing unit operated at the high rotational speed range;

FIGS. 10A to 10C show a control characteristic at a low rotational speed range when R=1.2×R* according to the first embodiment;

FIGS. 11A to 11C show control characteristic at a low rotational speed range when Ke=0.8×Ke* according to the first embodiment;

FIG. 12 is a block diagram of a motor control system of a second embodiment according to the present invention; and

FIG. 13 is a block diagram of a motor control system of a third embodiment according to the present invention.

The same or corresponding elements or parts are designated with like references throughout the drawings.

### DETAILED DESCRIPTION OF THE INVENTION

Prior to describing an embodiment of the present invention, the above-mentioned related art will be further explained.

The technology described in JP 2004-7924A aims to provide driving a motor at an optimum operating point in an output torque of the motor by using a counter voltage coefficient φ obtained by the counter voltage coefficient identifier in a motor controlling computing unit. Thus JP 2004-7924A does not describe affection on setting error of a resistance and identifying method at a low rotational speed range which would become a problem in a position sensor less control.

The present invention provides a controller and a system for a permanent magnet synchronous motor capable of identifying a motor constant at both low and high rotational speed ranges.

According to the present invention, it is possible to identify the motor constant at both low and high rotational speeds. The present invention is capable of suppressing step out with high stability at a low rotational speed range, and at a high rotational speed range, accuracy in rotational speed control can be improved, so that accuracy in control can be improved.

### First Embodiment

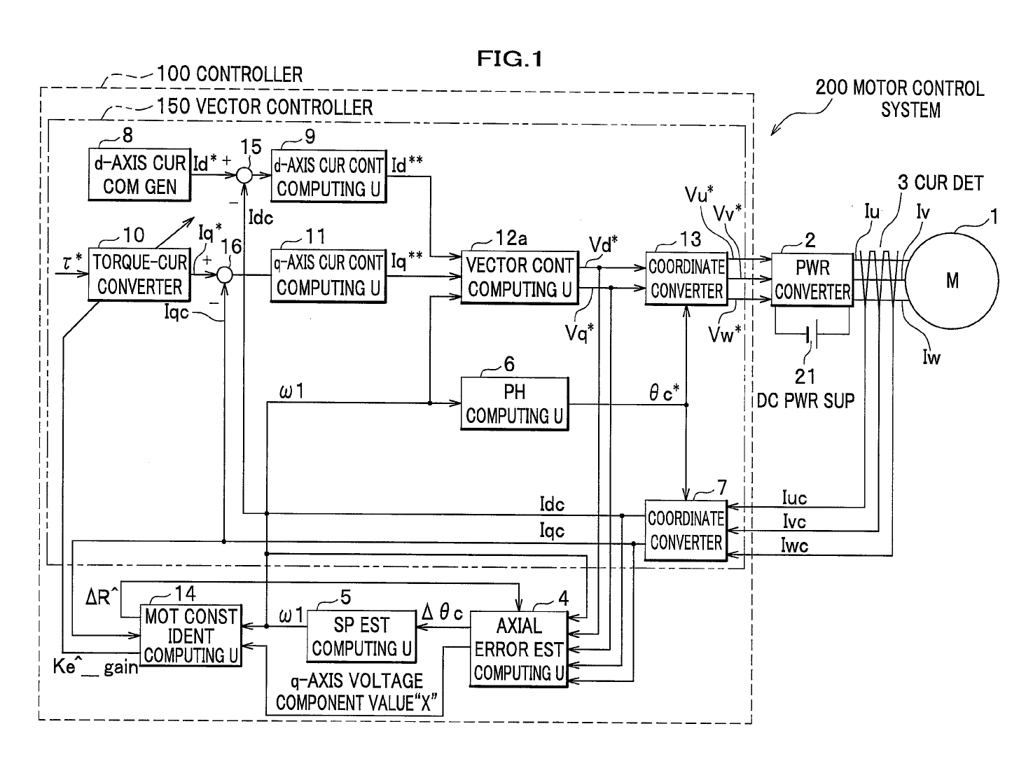

FIG. 1 is a block diagram of a motor control system of a first embodiment according to the present invention.

As shown in FIG. 1, the motor control system 200 for controlling a permanent magnet synchronous motor 1 includes a power converter 2, a current detector 3, a DC power supply 21, and a controller 100, in which a vector controller 150 in the controller 100 performs dq vector control toward a torque command τ* as a target value.

The permanent magnet synchronous motor 1 is configured to rotate a rotor with permanent magnets inside a stator with a voltage-current characteristic of an exciting axis (d axis) and a torque axis (q axis) determined by motor constants (R, Ld, Lq, Ke). The power converter 2 outputs three-phase AC voltages obtained by PWM modulating a DC voltage through comparing voltage commands Vu*, Vv*, and Vw* with a triangle waveform. The current detector 3 detects three-phase AC currents Iu, Iv, and Iw flowing through the permanent magnet synchronous motor 1. The DC power supply 21 supplies a DC power to the power converter 2.

The controller 100 is configured with a ROM (Read Only Memory), an RAM (Random Access Memory), and a CPU (Central Processing Unit) to include an axial error estimation computing unit 4, a speed estimation computing unit 5, a motor constant identification computing unit 14, and a vector controller 150. The vector controller 150 includes a phase computing unit 6, a coordinate converter 7, a d-axis current command generator 8, a d-axis current control computing unit 9, a torque-current converter 10, a q-axis current control computing unit 11, a vector control computing unit 12a, a coordinate converter 13, adders 15 and 16 as functions of the vector controller 150.

The axial error estimation computing unit 4 performs estimation computation of an axial error Δθ (=θc*−θ) which is a phase error between a reference axis θc* of control and a magnetic flux axis θ of the motor with a d-axis voltage command Vd*, a q-axis voltage command Vq*, a d-axis current detection value Idc, a q-axis current detection value Iqc, a rotational speed estimation value ω1, and an “identified value ΔR̂ of a setting error (R−R*) of a winding resistance” to output an axial error estimation value Δθc and a q-axis voltage component “X”.

The speed estimation computing unit 5 outputs a rotational speed estimation value ω1 which is PLL-controlled so that the axial error estimation value Δθc is identical with “zero” which is a command of the axial error.

The phase computing unit 6 performs an integration operation of the rotational speed estimation value ω1 to compute a rotational phase command θc* of the permanent magnet synchronous motor 1. The coordinate converter 7 generates a d-axis current detection values Idc and q-axis current detection value Iqc from detection value Iuc, Ivc, and Iwc of the three-phase AC current Iu, Iv, and Iw and a rotational phase command θc* of the permanent magnet synchronous motor 1. The d-axis current command generator 8 outputs a d-axis current command Id* which is “zero” when a weakened magnetic field operation is not performed.

The torque-current converter 10 converts a torque command τ* supplied from an upper layer into a q-axis current command Iq* in accordance with an identified value Kê_gain which is a value (a ratio between an induced voltage coefficient Ke and a setting value Ke*) obtained by dividing the induced voltage coefficient Ke by the setting value Ke*.

The d-axis current control computing unit 9 computes a second d-axis current command Id** in accordance with a deviation of a d-axis current detection value Idc from a first d-axis current command Id* (a difference between a d-axis current detection value Idc and a first d-axis current command Id*).

The q-axis current control computing unit 11 computes a second q-axis current command Iq** in accordance with a deviation of the q-axis current detection value Iqc from the first q-axis current command Iq* (a difference between the q-axis current detection value Iqc and the first q-axis current command Iq*).

Here, the d-axis current control computing unit 9 and the q-axis current control computing unit 11 each comprise an “element of a proportional operation+integration operation” or an “integration operation”.

The vector control computing unit 12a computes a voltage command Vd* and Vq* with the second d-axis current command Id**, the second q-axis current command Iq**, the rotational speed estimation value ω1, and setting values (R*, Ld*, Lq*, and Ke*) of the motor constants.

The coordinate converter 13 computes the three-phase AC voltage commands Vu*, Vv*, and Vw* with the voltage commands Vd* and Vq* and the rotational phase command θc*.

The motor constant identification computing unit 14 computes an identified value ΔR̂ of a setting error in the winding resistance and an identified value Kê_gain which is a ratio between the induced voltage coefficient Ke and the setting value Ke* from the q-axis voltage component value “X” and the rotational speed estimation value ω1 computed in the axial error estimation computing unit 4 and the setting value Ke* of the induced voltage coefficient Ke.

First, will be described a basic operations of voltage control and phase control.

The torque-current converter 10 converts the torque command τ* provided by the upper layer with Eq. (2) into the q-axis current command Iq*.

$${Iq}^{*} = \frac{{τ}^{*}}{\frac{3}{2} \cdot Pm \cdot {Ke}^{*} \cdot {Ke}^{⋀} \_gain} \qquad ( 2 )$$

where Pm: the number of pairs of magnet poles of the permanent magnet synchronous motor; Ke*: the setting value of the induced voltage coefficient Ke; and Kê_gain: the identified value (Ke/Ke*) of the ratio between the induced voltage coefficient Ke and the setting value Ke*.

Next, the d-axis current control computing unit 9 and the q-axis current control computing unit 11 compute the second current commands Id** and Iq** which are intermediate value used in the vector control operation from first current commands Id* and Iq* and the current detection values Idc and Iqc, respectively.

The vector control computing unit 12a computes the voltage commands Vd*, Vq* in Eq. (3) to control the voltage commands Vu*, Vv*, Vw* for the power converter 2 using the second current commands Id** and Iq**, the rotational speed estimation value ω1, and constant setting values (R*, Ld*, Lq*, and Ke*) of the permanent magnet synchronous motor 1.

$$[ \begin{matrix}{Vd}^{*} \\ {Vq}^{*}\end{matrix} ] = [ \begin{matrix}{R}^{*} & - {ω}_{1} \cdot {Lq}^{*} \\ {ω}_{1} \cdot {Ld}^{*} & {R}^{*}\end{matrix} ] \cdot [ \begin{matrix}{Id}^{**} \\ {Iq}^{**}\end{matrix} ] + [ \begin{matrix}0 \\ {ω}_{1} \cdot {Ke}^{*}\end{matrix} ] \qquad ( 3 )$$

where: R: a winding resistance; Ld: a d-axis inductance; and Lq: a q-axis inductance.

In the basic operation of the phase control, the axial error estimation computing unit 4 performs an estimation operation of the axial error value Δθ (=θc*−θ) which is a deviation of the rotational phase value θ from the rotational phase command θc* (a difference between the rotational phase value θ and the rotational phase command θc*) with the d-axis voltage command Vd*, the q-axis voltage command Vq*, the current detection values Idc, Iqc, the rotational speed estimation value ω1, the constant setting values (R*, Lq*) of the permanent magnet synchronous motor 1 and the “identified value ΔR̂ of the setting error (R−R*) in the winding resistance”. The axial error estimation value Δθc is determined by Eq. (4).

$$Δ θ c = {tan}^{- 1} ( \frac{{Vd}^{*} - ( {R}^{*} + Δ {R}^{⋀} ) \cdot Idc + {ω}_{1} \cdot {Lq}^{*} \cdot Iqc}{{Vq}^{*} - ( {R}^{*} + Δ {R}^{⋀} ) \cdot Iqc - {ω}_{1} \cdot {Lq}^{*} \cdot Idc} ) \qquad ( 4 )$$

The speed estimation computing unit 5 computes the rotational speed estimation value ω1 with Eq. (5) so that the estimation phase error Δθc becomes “zero” through a PLL control.

$${ω}_{1} = - Δ θ c \cdot ( Kp + \frac{Ki}{S} ) \qquad ( 5 )$$

where: Kp: a proportional gain; Ki: an integration gain; and S: a Laplace operator.

The phase computing unit 6 controls the rotational phase estimation value θc* through operation given by Eq. (6) with the rotational speed estimation value ω1.

$$θ {c}^{*} = {ω}_{1} \cdot \frac{1}{S} \qquad ( 6 )$$

The above is the basic operations of the voltage control and the phase control in the vector controller 150.

The inventors simulated a motor controller system which is derived by eliminating the “motor constant identification computing unit 14” in the motor control system 200, i.e., a motor controller system of which setting values of the vector controller 150 are fixed with respect to a control characteristic.

The simulated motor controller system shown in FIG. 1 is operated at a constant rotational speed at a low rotational speed range (several percentages of a rated rotational speed) and a load torque τL varying in a ramp is applied.

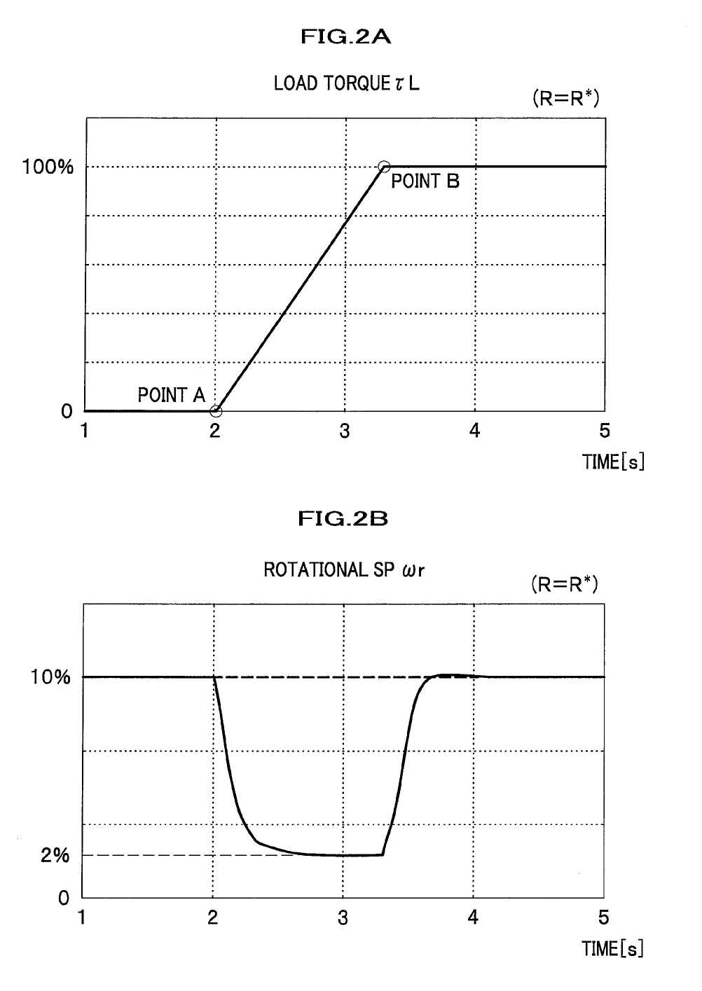

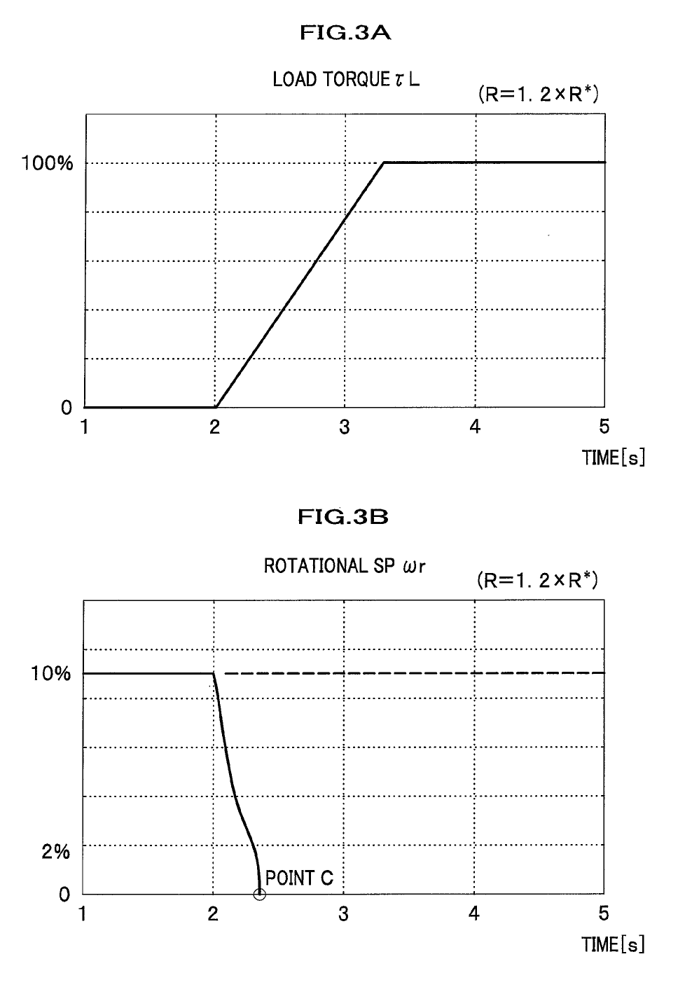

FIGS. 2A, 2B, 3A, and 3B show a control characteristic regarding the winding resistance of the permanent magnet synchronous motor 1 and an error (present/absent) in setting value R* of the axial error estimation computing unit 4 and the vector controller 12a.

At the low speed range, variation in the winding resistance R of the permanent magnet synchronous motor 1 is important in stability.

FIGS. 2A and 2B show a control characteristic when the winding resistance R of the permanent magnet synchronous motor 1 is identical with the setting value R* set in the axial error estimation computing unit 4 and the vector controller 12a (R=R*), and the abscissa represents time [s]. While the permanent magnet synchronous motor 1 is rotated at a rotational speed of 10% of a rated speed, a ramp load torque τL (0 to 100%) is applied to the permanent magnet synchronous motor 1 from a point (time) A to a point (time) B in FIG. 2A.

In the period from time A to time B where the load torque τL varies, the rotational speed or shown in FIG. 2B decreases from a 10%-speed to a 2%-speed. However, after time B, the rotational speed returns to the 10%-speed and is stably maintained.

However, in a case of a high load operation where the load torque τL increases during rotating, and in a case where the load torque τL is continuously applied, the winding resistance R of the permanent magnet synchronous motor 1 increases due to generation of heat, so that the setting error (R−R*) is developed.

FIGS. 3A and 3B show a control characteristic when the winding resistance R increases by 20% (R=1.2×R*) where the abscissa represents time [s]. When the load torque τL linearly increases as shown in FIG. 3A, the permanent magnet synchronous motor 1 decreases in the rotational speed at a point (time) C and becomes inoperative (step out).

This is because when the setting error (R−R*) occurs in a state of R>R*, a dominator value “X” which is a q-axis voltage component in the axial error estimation computing unit 4 becomes greater. In other words, this is caused by decrease in an estimation accuracy of the rotational speed estimation value ω1 (the rotational speed car of the permanent magnet motor 1 largely varies, but a variation range of the rotational speed estimation value ω1 is small).

Similarly in a high rotational speed range (higher than tens percents of the rated rotational speed), when the load torque τL varying in a form of a ramp in a constant rotational speed operation is applied to the permanent magnetic synchronous motor 1, a variation of the induced voltage coefficient Ke of the permanent magnet synchronous motor 1 becomes a problem.

In the high rotational speed range, in a case of a high load operation where the load torque τL increases during rotating, and in a case where the load torque τL is continuously applied, in the permanent magnet synchronous motor 1, the induced voltage coefficient Ke decreases with the setting error (Ke−Ke*).

The inventor simulated the motor controller system which is derived by eliminating the motor constant identification computing unit 14 in the motor control system 200 and a constant rotational speed operation is performed in the high rotational speed range (higher than tens percents of the rated rotational speed), and the ramp load torque τL is applied to the permanent magnet synchronous motor 1.

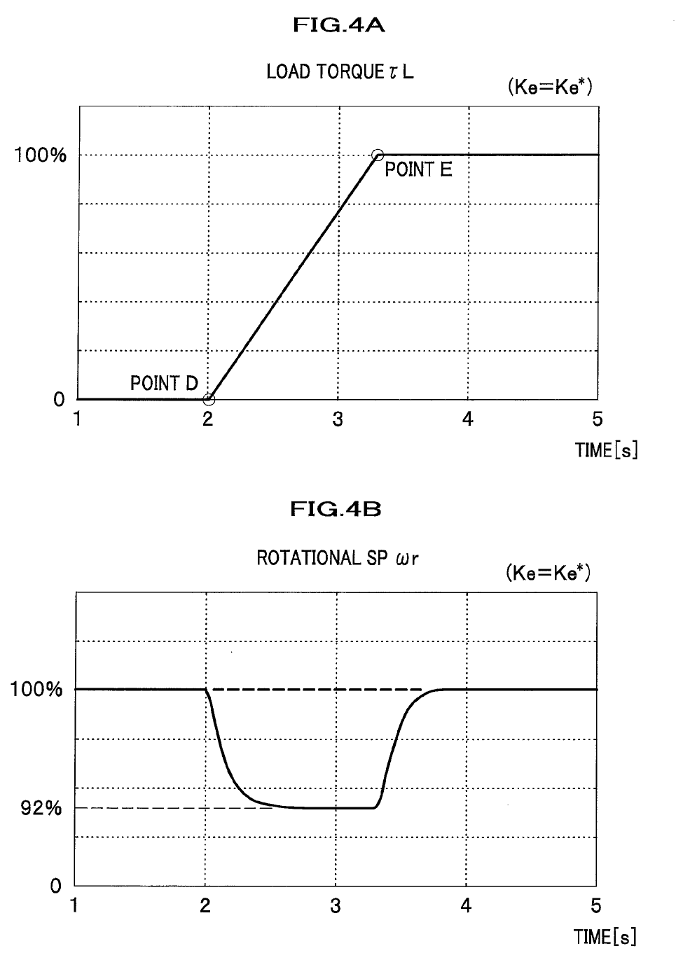

FIG. 4 shows a control characteristic of (Ke=Ke*) when the induced voltage coefficient Ke of the permanent magnet synchronous motor 1 is identical with the setting value Ke* set in the torque-current converter 10 and the vector controller 12a. While the permanent magnet synchronous motor 1 rotates at a constant rotational speed ωr of 100%-speed, the ramp load torque τL (0 to 100%) is applied from a point (time) D to a point (time) E.

In the period (from time D to time E) where the load torque τL varies, the rotational speed ωr decreases to 92%-speed. However, after time E, the rotational speed or returns to the 100%-speed and the permanent magnet synchronous motor 1 is operated stably with a high accuracy.

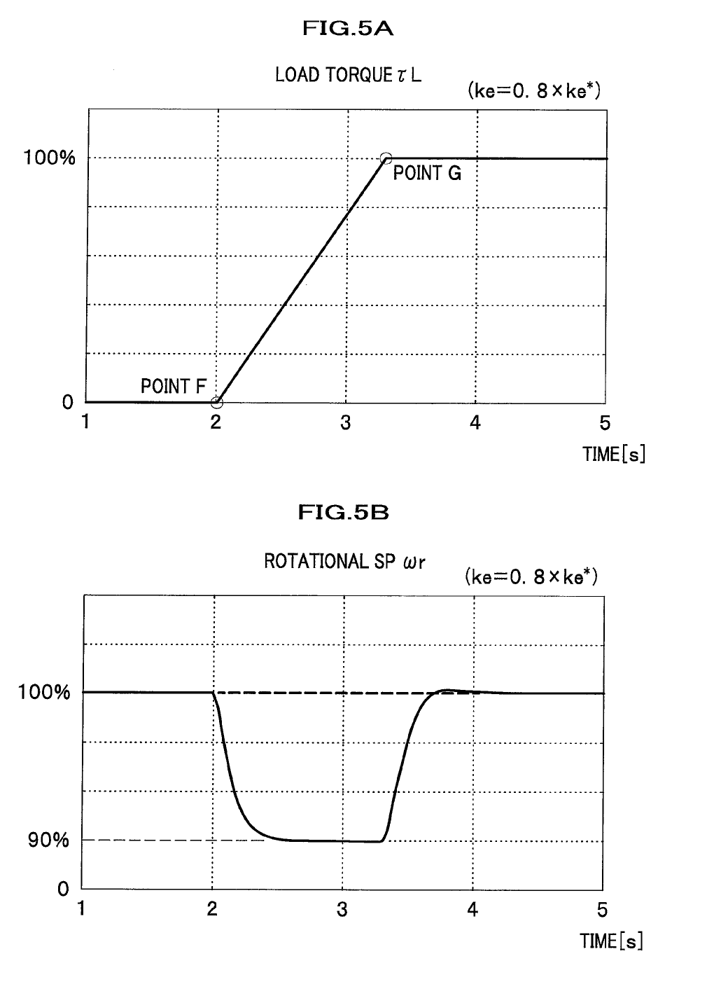

FIGS. 5A and 5B show a control characteristic when the induced voltage coefficient Ke decreases by 20% (Ke=0.8×Ke*). Even if the error (Ke−Ke*) of the induced voltage coefficient occurs, a stable operation is possible. However, from a point (time) F to a point (time) G, the rotational speed or shown in FIG. 5B decreases by about 2% from the error (Ke=K*) shown in FIGS. 4A and 4B. This is caused by computing the q-axis current command Iq* with the setting value Ke* in the control system. The lower an inertia value of the load is, the larger the deviation in the rotational speed or becomes. In other words, when the inertial value is low, the deviation of the rotational speed or becomes tens %.

As mentioned above, the control characteristic becomes degraded due to the setting error (R−R*) of the winding resistance in the low speed range and due to the setting error (Ke*−Ke) of the induced voltage coefficient in the high speed range.

Hereinafter will be described “identification theory of the motor constant” which is a feature of the present invention.

The vector controller 12a computes the voltage command Vd* and Vq* given in Eq. (3). Voltages Vd and Vq applied to the permanent magnet synchronous motor 1 are given in Eq. (7) with the d-axis current Id, the q-axis current Iq, and the motor constants (R, Ld, Lq, and Ke) of the permanent magnet synchronous motor 1.

$$[ \begin{matrix}Vd \\ Vq\end{matrix} ] = [ \begin{matrix}R & - {ω}_{r} \cdot Lq \\ {ω}_{r} \cdot Ld & {R}^{*}\end{matrix} ] \cdot [ \begin{matrix}Id \\ Iq\end{matrix} ] + [ \begin{matrix}0 \\ {ω}_{r} \cdot Ke\end{matrix} ] \qquad ( 7 )$$

In this condition, if the PLL control is performed so that the axial error Δθ=0, in which case right sides of Eqs. (3) and (7) are identical with each other, output values Id** and Iq** of the d-axis current control computing unit 9 and the q-axis current control computing unit 11 are given by Eq. (8).

$$[ \begin{matrix}{Id}^{**} \\ {Iq}^{**}\end{matrix} ] = [ \begin{matrix}\frac{\begin{matrix}( R \cdot {R}^{*} + {ω}_{1}^{2} \cdot Ld \cdot {Lq}^{*} ) \cdot Idc + {ω}_{1} \cdot \\ ( R \cdot {Lq}^{*} - {R}^{*} \cdot Lq ) \cdot Iqc + {ω}_{1}^{2} \cdot {Lq}^{*} \cdot ( Ke - {Ke}^{*} )\end{matrix}}{{R}^{* 2} + {ω}_{1}^{2} \cdot {Ld}^{*} \cdot {Lq}^{*}} \\ \frac{\begin{matrix}( R \cdot {R}^{*} + {ω}_{1}^{2} \cdot {Ld}^{*} \cdot Lq ) \cdot Iqc + {ω}_{1} \cdot \\ ( {R}^{*} \cdot Ld - R \cdot {Ld}^{*} ) \cdot Idc + {ω}_{1} \cdot {r}^{*} \cdot ( Ke - {Ke}^{*} )\end{matrix}}{{R}^{* 2} + {ω}_{1}^{2} \cdot {Ld}^{*} \cdot {Lq}^{*}}\end{matrix} ] \qquad ( 8 )$$

This equation can be simplified because the d-axis current command Id** is set to “0”.

$${[ \begin{matrix}{Id}^{**} \\ {Iq}^{**}\end{matrix} ]}_{{Id}^{*} = 0} = [ \begin{matrix}\frac{\begin{matrix}{ω}_{1} \cdot ( R \cdot {Lq}^{*} - {R}^{*} \cdot Lq ) \cdot \\ Iqc + {ω}_{1}^{2} \cdot {Lq}^{*} \cdot ( Ke - {Ke}^{*} )\end{matrix}}{{R}^{* 2} + {ω}_{1}^{2} \cdot {Ld}^{*} \cdot {Lq}^{*}} \\ \frac{\begin{matrix}( R \cdot {R}^{*} + {ω}_{1}^{2} \cdot {Ld}^{*} \cdot Lq ) \cdot \\ Iqc + {ω}_{1} \cdot {r}^{*} \cdot ( Ke - {Ke}^{*} )\end{matrix}}{{R}^{* 2} + {ω}_{1}^{2} \cdot {Ld}^{*} \cdot {Lq}^{*}}\end{matrix} ] \qquad ( 9 )$$

Next, an operation in the axial error estimation computing unit 4 is considered.

The axial error estimation computing unit 4 computes the axial error estimation value Δθc with Eq. (4). Accordingly, the axial error Δθc can be computed, as given in Eq. (10) by substitution in Eq. (4) with Eqs. (3) and (9) with assumption that Id*=Idc, Iq*=Iqc, ω1=ωr.

$$Δ θ c = {tan}^{- 1} ( \frac{{ω}_{1} \cdot ( {Lq}^{*} - Lq ) \cdot Iqc}{( R - ( {R}^{*} + Δ {R}^{⋀} ) ) \cdot Iqc + {ω}_{1} \cdot Ke} ) \qquad ( 10 )$$

The inventors simulated a case where the motor constant identifying is eliminated (ΔR̂=0, Ke_gain=1) and considered a q-axis voltage component X₀ to examine a parameter sensitivity of the q-axis voltage component X=(R−(R*+ΔR̂))·Iqc+ω1·Ke in the dominator of Eq. (10) in the low and high rotational speed ranges.

First, the parameter sensitivity in the low rotational speed range is checked.

As shown in Eq. (11), the q-axis voltage component of “X₀” in the dominator in Eq. (10), the q-axis voltage component X₀ (ΔR̂=0) includes the setting error (R−R*) of the winding resistance.

X₀=(R−R*)·Iqc+ω₁·Ke (11)

The q-axis voltage components X₀ is represented and modified regarding the setting errors (R−R*).

$$( R - {R}^{*} ) = \frac{{X}_{0} - {ω}_{1} \cdot Ke}{Iqc} \qquad ( 12 )$$

Then, it is assumed that the setting error (R−R*) of the winding resistance to be identified is ΔR̂, and when the operation in Eq. (4) is performed in consideration of ΔR̂, a feedback loop is formed, so that the setting error ΔR̂ can be identified with the q-axis voltage component “X” in the dominator.

$$Δ {R}^{⋀} = \frac{K}{S} \cdot ( X - {ω}_{1} \cdot {Ke}^{*} ) \qquad ( 13 )$$

where K is an integration gain.

The q-axis voltage component “X” in the dominator in Eq. (10) is given in Eq. (14) with the setting error ΔR̂=(R−R*).

X=(R−(R*+ΔR̂))·Iqc+ω₁·Ke (14)

Further, when the rotational speed ωr of the permanent magnet synchronous motor 1 is extremely small around zero and thus, within a range where a relation given by Eq. (15) is established.

|R*·Iqc| [symbol] ω₁·Ke (15)

In place of Eq. (13), Eq. (16) can be operated.

$$Δ {R}^{⋀} = \frac{K}{S} \cdot X \qquad ( 16 )$$

In the low rotational speed range, the winding resistance R of the permanent magnet synchronous motor 1 can be identified with the q-axis voltage component “X” in the dominator in Eq. (10). The axial error estimation with the identified value ΔR̂ provides a control characteristic which is robust and stable against variation of the winding resistance R.

On the other hand, in the high speed range, Eq. (17) is given.

|(R−(R*+ΔR̂))·Iqc| [symbol] ω₁·Ke (17)

Then, the q-axis voltage component “X” in the dominator in the axial error estimation computing unit 4 is given by Eq. (18).

X≈Ke·ω₁ (18)

Then, the identifying operation of the ratio of (Ke/Ke*) between the induced voltage coefficient Ke and the setting value Ke* of the permanent magnet synchronous motor 1 is performed with Eq. (19).

$${Ke}^{⋀} \_gain = \frac{X}{{ω}_{1} \cdot {Ke}^{*}} \qquad ( 19 )$$

Next, when substitution of Eq. (18) is performed in Eq. (19), the identified value Kê_gain is given by Eq. (20).

$${Ke}^{⋀} \_gain = \frac{Ke}{{Ke}^{*}} \qquad ( 20 )$$

Generally, the q-axis current command Iq* is operated by Eq. (21) with the setting value Ke* of the induced voltage coefficient.

$${Iq}^{*} = \frac{{τ}^{*}}{\frac{3}{2} \cdot Pm \cdot {Ke}^{*}} \qquad ( 21 )$$

In this embodiment, the operation of Eq. 22 is performed with the identified value Kê_gain, i.e., the ratio between the induced voltage coefficient Ke and the setting value Ke* (Ke/Ke*).

$$\begin{matrix}{Iq}^{*} = \frac{{τ}^{*}}{\frac{3}{2} \cdot Pm \cdot {Ke}^{*} \cdot {Ke}^{⋀} \_gain} \\ = \frac{{τ}^{*}}{\frac{3}{2} \cdot Pm \cdot Ke}\end{matrix} \qquad ( 22 )$$

In other words, identifying the ratio between the induced voltage coefficient Ke and the setting value Ke* (Ke/Ke*) is possible also in the high rotational speed range with the q-axis voltage component “X” in the dominator in the axial error computing unit 4.

When the torque-current conversion is performed with the identified value Kê_gain in the ratio, a control characteristic is provided which is robust against variation in the induced voltage coefficient. Hereinbefore, “the identification theory of the motor constant” is described.

Next, will be described a configuration of the controller 100.

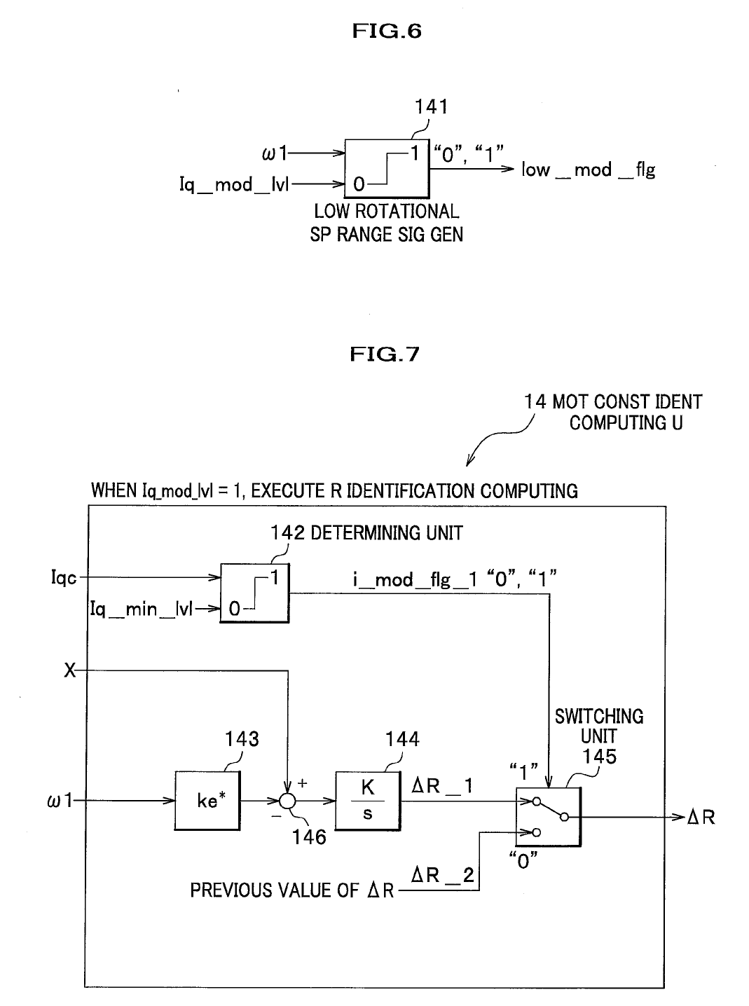

First, with reference to FIGS. 6 and 7, will be described “identification of the winding resistance R”.

A signal generator 141 for the low rotational speed range is included in the motor constant identification computing unit 14 (see FIG. 1) and supplied with the rotational speed estimation value ω1 and generates a determination flag (low_mod_flg) in a relation given in Eq. (23) by comparing the input rotational speed estimation value ω1 with a low rotational speed detection level (low_mod_lvl).

$$( \begin{matrix}{ω}_{1} ≧ low\_mod \_lvl \text{:} & low\_mod \_flg = 0 \\ {ω}_{1} < low\_mod \_lvl \text{:} & low\_mod \_flg = 1\end{matrix} ) \qquad ( 23 )$$

The motor constant identification computing unit 14 determines that the rotational speed is in the low rotational speed range, when the determination flag is “1”, and performs an identifying operation of the winding resistance.

The low rotational speed level is required to satisfy a relation given by Eq. (24).

$$low\_mod \_lvl ≪ \frac{{R}^{*} \cdot lq\_min \_lvl}{{Ke}^{*}} \qquad ( 24 )$$

where Iq_min_lvl is a predetermined current level and is sufficient as long as Iq_min_lvl is a current detection level capable of the identification operation. More specifically, Iq_min_lvl is several percents of the rated current.

With reference to FIG. 7, will be described “identifying operation process of the winding resistance R.”

The motor constant identification computing unit 14 includes a determining unit 142, a multiplier 143, an adder 146, an integrator 144, and a switching unit 145.

The determining 142 inputs the q-axis current detection value Iqc which is compared with a predetermined current level (Iq_min_lvl) and generates a determination flag (i_mod_flg_1) of a relation given by Eq. 25.

$$( \begin{matrix}Iqc ≧ Iq\_min \_lvl \text{:} & i\_mod \_flg \_ 1 = 1 \\ Iqc < Iq\_min \_lvl \text{:} & i\_mod \_flg \_ 1 = 0\end{matrix} ) \qquad ( 25 )$$

The multiplier 143 multiplies the rotational speed estimation value ω1 by a constant Ke* which is a setting value of the induced voltage coefficient. The adder 146 subtracts the multiplied value Ke*·ω1 obtained by the multiplier 143 from the q-axis voltage component value X. The integrator 144 integrates the output signal of the adder 146 to have a signal which is K/s-times the output signal of adder 146 and outputs an output value of ΔR_1.

The switching unit 145 outputs ΔR_1 which is the output value of the integrator 144 when the determination flag (i_mod_flg_1) of the determining unit 142 is “1” and outputs ΔR_2 which is a previous value of the identifying operation value ΔR outputted at the switching unit 145 when the determination flag (i_mod_flg_1) is “0”.

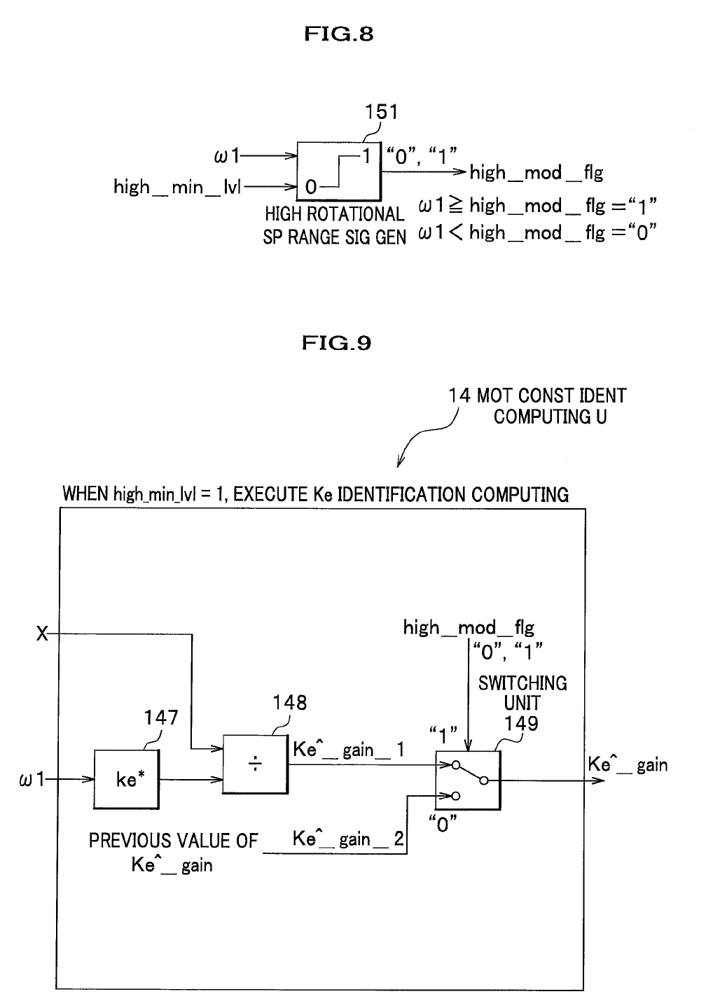

With reference to FIGS. 8 and 9 will be described “an identifying operation of the induced voltage coefficient Ke” executed in the high rotational speed range.

A high rotational speed range signal generator 151 inputs the rotational speed estimation value ω1, compares the rotational speed estimation value ω1 with the rotational speed range detection level (high_mod_lvl) and generates a determination flag (high_mod_flg) given by Eq. (26).

$$( \begin{matrix}{ω}_{1} ≧ high\_mod \_lvl \text{:} & high\_mod \_flg = 1 \\ {ω}_{1} < high\_mod \_lvl \text{:} & high\_mod \_flg = 0\end{matrix} ) \qquad ( 26 )$$

The motor constant identification computing unit 14 performs the identifying operation of the induced voltage coefficient when the determination flag is “1” because the rotational speed is at the high rotational speed range.

The high rotational speed detection level is determined so as to satisfy a relation given by Eq. (27).

$$high\_mod \_lvl ≫ \frac{{R}^{*} \cdot Iq\_min \_lvl}{{Ke}^{*}} \qquad ( 27 )$$

With reference to FIG. 9 will be described the “identifying operation process of the induced voltage coefficient Ke.”

The motor coefficient identifier 14 further includes a multiplier 147, a divider 148, and a switch 149 to operate an identified value Kê_gain with the q-axis voltage component value “X” and the rotational speed estimation value ω1. The multiplier 147 multiplies the rotational speed estimation value ω1 by a setting value Ke* of the induced voltage coefficient Ke. The divider 148 divides the q-axis voltage component value “X” by the multiplied result ω1·Ke* on the basis of Eq. (19).

The switch 149 outputs an output Kê_gain_1 of the divider 148 when the determination flag (high_mod_flg) is “1” and outputs a previous value Kê_gain_2 of the identified operation value Kê_gain which is a setting ratio (Ke/Ke*) of the induced voltage coefficient which is the output of the switch 149 when the determination flag (high_mod_flg) is “0”.

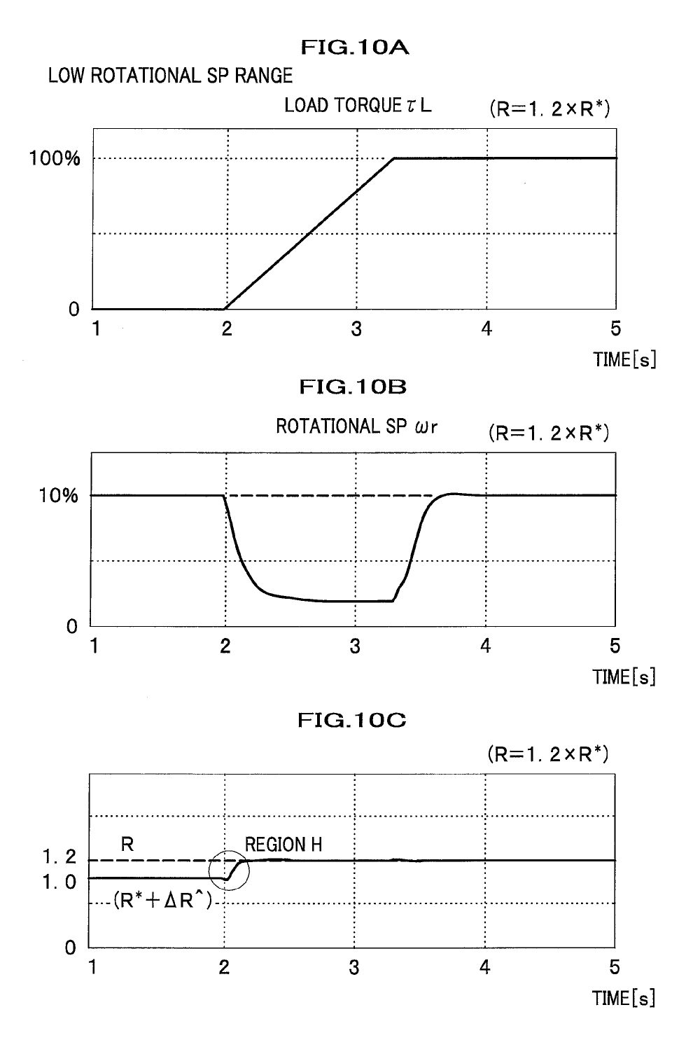

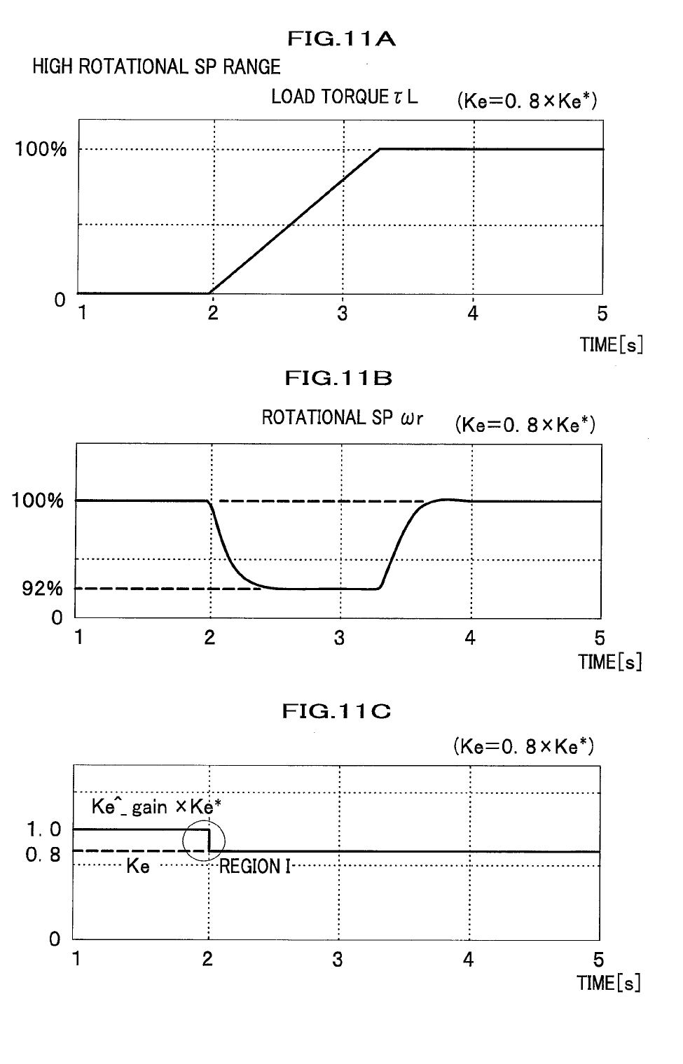

FIGS. 10A to 10C and 11A to 11C show control characteristics when the “identifying operation of the motor constant” is performed.

FIGS. 10A to 10C show a control characteristic at the low rotational speed and the abscissa represents time [s]. FIG. 10A shows a load torque τL when the winding resistance R of the permanent magnet synchronous motor 1 increases by 20% from the setting value R*(R=1.2×R*), FIG. 10B shows the rotational speed ωr, and FIG. 10C shows the winding resistance R with a broken line and a sum (setting value R*+identified value ΔR̂) with a solid line.

In a region H surrounded by a circle in FIG. 10C performed is an estimation operation of ΔR̂.

After the region H, the solid line representing the sum of “the identified value ΔR̂ and the setting value R*” overlaps the winding resistance R of the permanent magnet synchronous motor 1 (1.0 to 1.2). Accordingly, the control provides a stable control characteristic without entering the inoperative condition (step out) as shown in FIGS. 3A and 3B.

FIGS. 11A to 11C show a control characteristic in the high rotational range in which FIG. 11A shows a load torque τL, FIG. 11B shows the rotational speed ωr, and FIG. 11C shows the induced voltage coefficient Ke (broken line) and the setting ratio of the induced voltage coefficient (Kê_gain×Ke*) (a solid line), when the induced voltage coefficient Ke of the permanent magnet synchronous motor 1 decreases by 20% (Ke=0.8×Ke*).

In a region I surrounded by a circle in FIG. 11C, the estimation operation of the setting value (Kê_gain) according to the first embodiment is performed.

After the region I, a solid line of “a multiplied value between Kê_gain and Ke* overlaps a broken line of the induced voltage coefficient Ke of the permanent magnet synchronous motor 1 (1.0 to 0.8).

In other words, in FIG. 11B, the rotational speed ωr is 92% of the rated rotational speed and does not enter the condition shown in FIG. 5B, wherein a high accurate control is provided.

### Second Embodiment

In the first embodiment, the motor constants in the torque-current converter 10 and the axial error estimation computing unit 4 are corrected with the output ΔR̂, Kê_gain of the motor constant identification computing unit 14. However, this is also applicable to the setting value in the vector controller 12 with the output ΔR̂, Kê_gain.

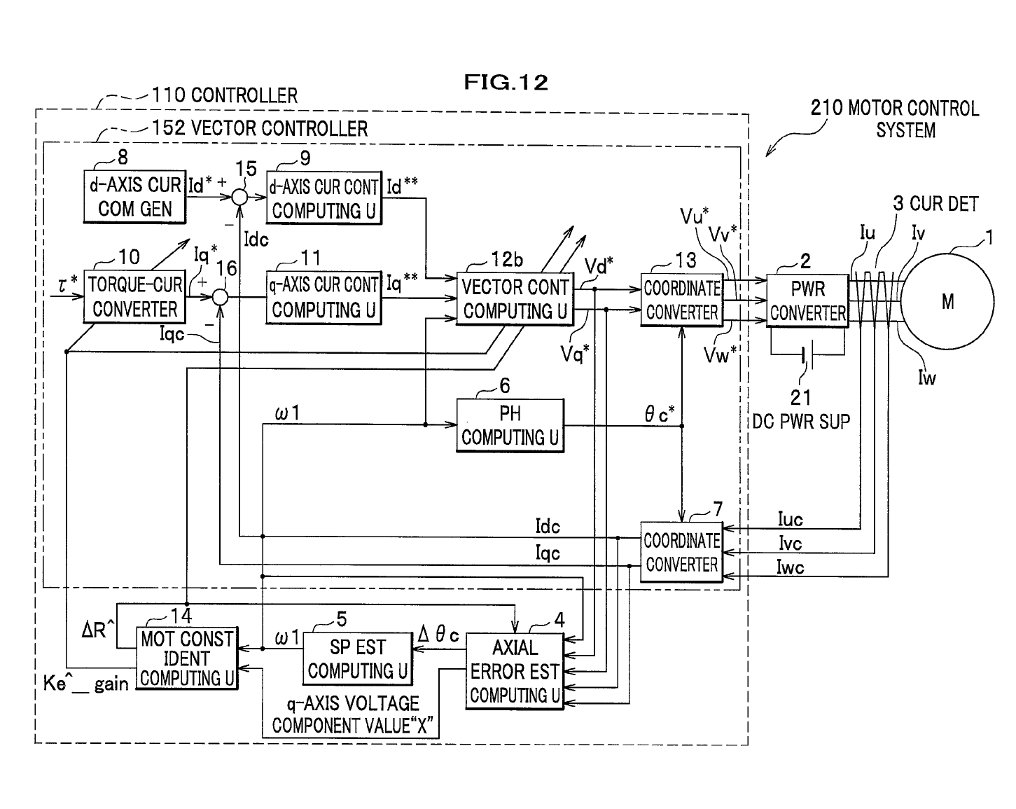

FIG. 12 is a block diagram of a second embodiment. The configuration shown in FIG. 12 is similar to that in FIG. 1, wherein the vector controller 12a is replaced with a vector controller 12b. More specifically, a motor control system 210 includes a controller 110 which includes a vector controller 152. The vector controller 152 includes the vector control computing unit 12b and the remaining part is similar to that shown in FIG. 1.

The vector control computing unit 12b outputs a d-axis voltage command Vd* and a q-axis voltage command Vq* given in Eq. (28).

$$[ \begin{matrix}{Vd}^{*} \\ {Vq}^{*}\end{matrix} ] = [ \begin{matrix}( {R}^{*} + Δ {R}^{⋀} ) + & - {ω}_{1} \cdot {Lq}^{*} \\ {ω}_{1} \cdot {Ld}^{*} & ( {R}^{*} + Δ {R}^{⋀} )\end{matrix} ] \cdot [ \begin{matrix}{Id}^{**} \\ {Iq}^{**}\end{matrix} ] + [ \begin{matrix}0 \\ {ω}_{1} \cdot {Ke}^{*} \cdot {Ke}^{⋀} \_gain\end{matrix} ] \qquad ( 28 )$$

According to the second embodiment, the vector control computing unit 12b performs operations with the identified value (ΔR̂, Kê_gain) of constants of the permanent magnet synchronous motor 1, which provides a vector control system with a high accuracy.

### Third Embodiment

In the first embodiment, the motor constants in the torque-current converter 10 and the axial error estimation computing unit 4 are corrected with the output values (ΔR̂, Kê_gain) of the motor constant identification computing unit 14. However, this is also applicable to a control gain operation in the d-axis current control computing unit 9 with the output ΔR̂ and the q-axis current control computing unit 11 is performed.

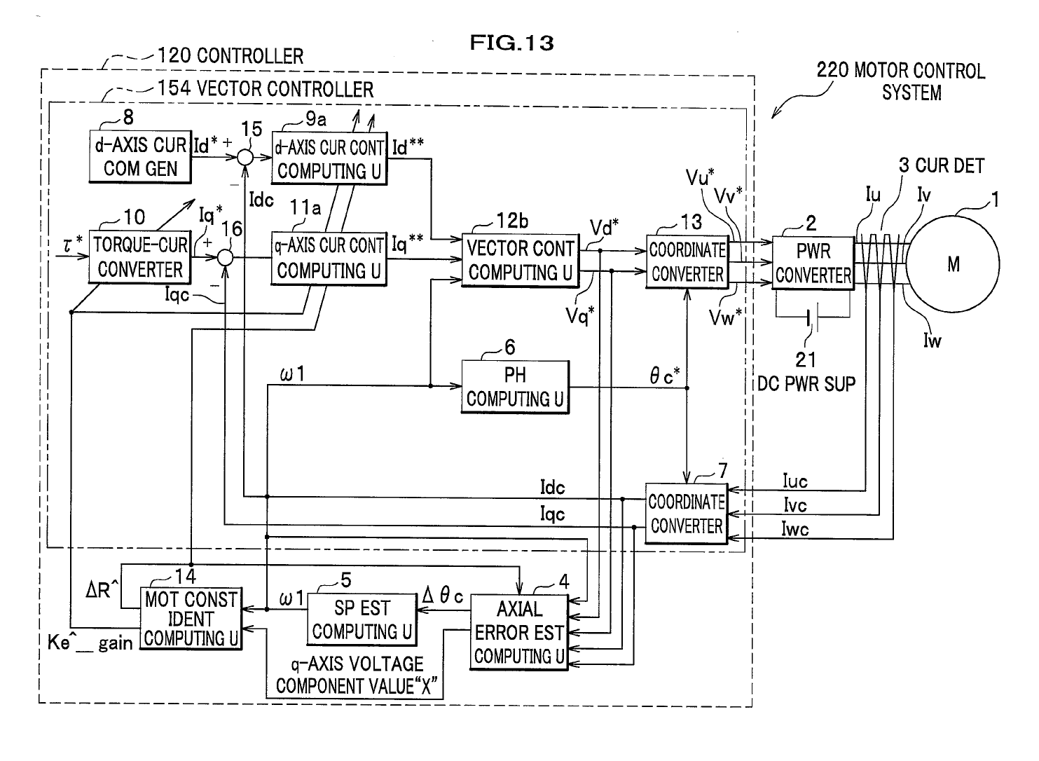

FIG. 13 is a block diagram of a third embodiment. The motor control system 220 includes a controller 120 which includes a vector controller 154. The configuration of the vector controller 154 is similar to the vector controller 150 in FIG. 1, wherein the d-axis current control computing unit 9 is replaced with a d-axis current computing unit 9a, and the q-axis current control computing unit 11 is replaced with a q-axis current computing unit 11a.

As shown in Eq. (29), correcting the control gains (Kp_d and Kp_q) in the d-axis current computing unit 9a and the q-axis current computing unit 11a with the identified value R̂ of the constant of the permanent magnet synchronous motor 1 provides a torque control system with a high response.

Further, a torque coefficient may be corrected.

$$( \begin{matrix}Kp\_d = {ω}_{c} \_acr \cdot \frac{{Ld}^{*}}{( {R}^{*} + {R}^{⋀} )} \\ Ki\_d = {ω}_{c} \_acr \\ Kp\_q = {ω}_{c} \_acr \cdot \frac{{Lq}^{*}}{( {R}^{*} + {R}^{⋀} )} \\ Ki\_q = {ω}_{c} \_acr\end{matrix} ) \qquad ( 29 )$$

where

Kp_d: a proportional gain for the second d-axis current control operation;

Ki_d: an integration gain;

Kp_q: a proportion gain for the second q-axis current control operation;

Ki_q: an integration gain; and

ωc_acr: current control response angular frequency [rad/s].

### Modification

The present invention is not limited to the above-mentioned embodiments, but may be modified into various modifications as follows:
(1) In the first to third embodiments, the second current commands (Id**, Iq**) are generated from the first current commands (Id*, Iq*) and current detection values (Idc, Iqc) and the vector control operation is performed with the current commands.

(a) However, it is possible to generate the voltage correction values (ΔVd*, ΔVq*) from the first current commands (Id*, Iq*) and current detection values (Idc, Iqc) and operate the voltage commands (ΔVd*, ΔVq*) through Eq. (30) with the voltage correction values (ΔVd*, ΔVq*), the first current commands (Id*, Iq*), the rotational speed estimation values ω1, and constants of the permanent magnet synchronous motor 1.

(b) Further it is also possible to operate the voltage command Vd*, Vq* through Eq. (31) with the first d-axis current command Id* (=0), a primary delay signal Iqctd of the q-axis current detection value Iqc, a rotational speed command ωr*, and the constants of the permanent magnet synchronous motor 1.
(2) In the first to third embodiments, the three phase ac current Iu, Iv, Iw are detected by the current detector 3 which is costly. However, this invention is also applicable to a low cost system in which a three phase motor currents Iû, Iv̂, Iŵ are reproduced from a dc current flowing through a one shunt resistor provided for detecting an over current of the power converter 2.

$$\begin{matrix}[ \begin{matrix}{Vd}^{*} \\ {Vq}^{*}\end{matrix} ] = [ \begin{matrix}{R}^{*} & - {ω}_{1} \cdot {Lq}^{*} \\ {ω}_{1} \cdot {Ld}^{*} & {R}^{*}\end{matrix} ] \cdot [ \begin{matrix}{Id}^{*} \\ {Iq}^{*}\end{matrix} ] + [ \begin{matrix}0 \\ {ω}_{1} \cdot {Ke}^{*}\end{matrix} ] + [ \begin{matrix}Δ Vd \\ Δ Vq\end{matrix} ] & ( 30 ) \\ [ \begin{matrix}{Vd}^{*} \\ {Vq}^{*}\end{matrix} ] = [ \begin{matrix}{R}^{*} & - {ω}_{r}^{*} \cdot {Lq}^{*} \\ {ω}_{r}^{*} \cdot {Ld}^{*} & {R}^{*}\end{matrix} ] \cdot [ \begin{matrix}{Id}^{*} \\ {Iqc}_{td}\end{matrix} ] + [ \begin{matrix}0 \\ {ω}_{r}^{*} \cdot {Ke}^{*}\end{matrix} ] & ( 31 )\end{matrix}$$

The embodiments of the present invention provides a control characteristic in the vector control method of the permanent magnet synchronous motor with a high accuracy and a high response by identifying the winding resistance and the induced voltage coefficient which varies in accordance the ambient temperature just before an actual operation or during an actual operation. (3) In the above-mentioned embodiments, the motor constant identification computing unit 14 identifies the motor constants with the rotational speed command. However, if a rotational speed control is performed, it is also possible to identify with the rotational speed.

As mentioned above, the present invention provides the controller 100 (110, 120) for controlling the power converter 2 to be connected to the permanent magnet synchronous motor 1, including: the current detector 3 configured to detect a current flowing through the permanent magnet synchronous motor; a vector controller 150 (152, 154) configured to, on the basis the detected current Uuc, Ivc, Iwc, generate control signals (Vu*, Vv*, Vw*) for controlling the power converter 2; the axial error estimation computing unit 4 configured to estimate axial error information Δθc which is a difference between a phase estimation value θc* obtained by integrating a rotational speed estimation value ω1 of the permanent magnet synchronous motor 1 and the phase value θ of the permanent magnet synchronous motor 1 and generate a q-axis voltage component value X on the basis of voltage command signals Vd*, Vq* and the detected current Uuc, Ivc, Iwc,; a rotational speed estimation value computing unit 5 configured to perform control so that the axial error information Δθc estimated by the axial error estimation computing unit 4 is identical with an axial error information command θc*; and a motor constant identification computing unit 14 configured to identify a motor constant of the permanent magnet synchronous motor with the q-axis voltage component value and at least one of the rotational speed estimation value ω1 of the permanent magnet synchronous motor 1 and the rotational speed command ωr* and reflect the identified motor constant in controlling the power converter 2 by the vector controller 150 (152, 154).

The invention claimed is:

1. A controller for controlling a power converter to be connected to a permanent magnet synchronous motor, comprising:
a current detector configured to detect a current flowing through the permanent magnet synchronous motor;
a vector controller configured to, on the basis the detected current, generate a control signal for controlling the power converter;
an axial error estimation computing unit configured to estimate an axial error information which is a difference between a phase estimation value obtained by integrating a rotational speed estimation value of the permanent magnet synchronous motor and a phase value of the permanent magnet synchronous motor and generate a q-axis voltage component value on the basis of voltage command signals and the detected current;
a rotational speed estimation value computing unit configured to perform control so that the axial error information estimated by the axial error estimation computing unit is identical with an axial error information command; and
a motor constant identification computing unit configured to identify a motor constant of the permanent magnet synchronous motor with the q-axis voltage component value and either of the rotational speed estimation value of the permanent magnet synchronous motor or a rotational speed command and reflect the identified motor constant in controlling the power converter by the vector controller.

2. The controller as claimed in claim 1, wherein the identified motor constant comprises an induced voltage coefficient of the permanent magnet synchronous motor and a setting error of a winding resistance of the permanent magnet synchronous motor, and the axial error estimation computing unit computes the q-axis voltage component value from a sum of a product of the setting error of the winding resistance and a q-axis current estimation value estimated from the detected current and a product of the rotational speed estimation value and the induced voltage coefficient.

3. The controller as claimed claim 2, wherein the motor constant identifying computing unit identifies the winding resistance of the permanent magnet synchronous motor when at least one of the rotational speed estimation value and a rotational speed command value is lower than a first predetermined rotational speed at a low rotational speed range, and the motor constant identification computing unit identifies a ratio between the induced voltage coefficient of the identified motor constant and a setting value of the induced voltage coefficient in the vector controller when at least one of the rotational estimation value and the rotational speed command is higher than a second predetermined rotational speed at a high rotational speed range.

4. The controller as claimed in claim 1, wherein the motor constant identification computing unit multiplies, at the low rational speed range, the rotational speed estimation value or the rotational speed command by a setting value of the induced voltage coefficient of the permanent magnet synchronous motor to output a multiplied value, subtracts the multiplied value from the q-axis voltage component value to output a subtraction result, performs a proportional integration with the subtraction result to output a proportional integration result, adds the proportional integration result to the setting value of a winding resistance of the permanent magnet synchronous motor in the axial error estimation computing unit, and in a high rotational speed range, multiplies the rotational speed estimation value or the rotational speed command by the setting value of the induced voltage coefficient to output a multiplied result, computes a ratio between the multiplied result and the q-axis voltage component value, and corrects the setting value of a torque coefficient of the permanent magnet synchronous motor on the basis of the ratio.

5. The controller as claimed in claim 1, wherein the vector controller corrects the setting values of the permanent magnet synchronous motor used in generating the control signal with the motor constant identified by the motor constant identification computing unit.

6. The controller as claimed in claim 1, wherein the vector controller corrects a control gain with the identified constants of the motor identified by the motor constant identification computing unit.

7. A motor control system comprising: a permanent magnet synchronous motor; a power converter connected to the motor, a current detector configured to detect a current flowing through the permanent magnet synchronous motor, a controller generating a control signal for controlling the power converter; the controller comprising:
a vector controller configured to generate the control signal on the basis of the detected current;
an axial error estimating computing unit configured to estimate an axial error information which is a difference between a phase value of the motor and the phase estimation value obtained by integrating a rotational speed estimation value of the motor and generate a q-axis voltage component;
a rotational speed estimating computing unit for performing control so as to equalize the estimation value operated by the axial error estimating computing unit to a command of the axial error information, and
a motor constant identification computing unit configured to identify a motor constant of the permanent magnet synchronous motor with the q-axis voltage component and the rotational estimation value or a rotational speed command and reflects the identified motor constant in generating the control signal by the vector controller.
